(19) United States
(12) Patent Application Publication
(10) Pub. No.: US 2004/0018291 A1
(43) Pub. Date: Jan. 29, 2004

(54) Dough with impression area to promote folding

(76) Inventors: Kathy A. Nelson, Dallas, TX (US); Jennifer T. Nguyen, Dallas, TX (US)

Correspondence Address: DICKE, BILLIG & CZAJA, P.L.L.C., FIFTH STREET TOWERS, 100 SOUTH FIFTH STREET, SUITE 2250, MINNEAPOLIS, MN, 55402, US

(21) Appl. No.: 10/429,483

(22) Filed: May 5, 2003

Related U.S. Application Data
(60) Provisional application No. 60/378,268, filed on May 6, 2002.

(51) Int. Cl. A21D 10/00

(52) U.S. Cl. 426/549

(57) ABSTRACT

A dough base includes an outer portion, an inner portion, and an impression line between the outer portion and the inner portion, the impression line being adapted to aid bending of the dough base along the impression line. The inner portion of the dough base generally corresponds to the bottom of a receptacle into which the dough base will be placed. The outer portion of the dough base generally corresponds to a rim upstanding from the bottom of the receptacle into which the dough base will be placed. Certain embodiments of the invention provide a high-walled pizza crust made from a par-baked dough base. Additional products and methods provide similar advantages.

### CROSS-REFERENCE TO RELATED APPLICATION

The subject matter of this application is related to the subject matter of U.S. Provisional Patent Application No. 60/378,268, filed May 6, 2002, priority to which is claimed under 35 U.S.C. § 119(e) and which is incorporated herein by reference.

### BACKGROUND OF THE INVENTION

Pizza enjoys enormous popularity as a food item, both in the United States and abroad. Grocery stores, dine-in and carry-out restaurants, and other establishments collectively sell billions of dollars worth of pizza products every year. Many of the pizzas that people often consider the most flavorful and desirable are made from scratch at home, or are available only through specialty restaurants. In both cases, preparing such pizzas is operationally complex and requires a significant amount of time, and consumers of these pizzas typically are willing, or at least expect, to endure a long wait before partaking.

One particularly popular form of pizza product is the “Chicago” style, in which a high-walled pizza crust surrounds a substantial amount of cheese, sauce, vegetables, meats and/or other pizza ingredients. Preparing a filled or heavily topped Chicago-style pizza in a short amount of time presents unique challenges. At e.g. chain-based pizza restaurants, where customers typically expect relatively quick and efficient service, the time required to prepare a Chicago-style pizza can be prohibitive. Although pre-making and par-baking of pizza crusts can reduce pizza preparation time at such restaurants, such restaurants generally lack the equipment, space and/or personnel to do so. Even in central supply facilities that are adapted for mass production of crusts, creating and successfully shipping a high-walled, Chicago-style crust has been perceived, if at all, as very challenging.

### SUMMARY OF THE INVENTION

According to aspects of the invention, a dough base includes an outer portion, an inner portion, and an impression line between the outer portion and the inner portion, the impression line being adapted to aid bending of the dough base along the impression line, wherein the inner portion of the dough base generally corresponds to the bottom of a receptacle into which the dough base will be placed, further wherein the outer portion of the dough base generally corresponds to a rim upstanding from the bottom of the receptacle into which the dough base will be placed. Certain embodiments of the invention provide a high-walled pizza crust made from a par-baked dough base. Additional products and methods provide similar advantages.

### BRIEF DESCRIPTION OF THE DRAWINGS

Embodiments of the invention will be described with respect to the figures, in which like reference numbers denote like elements and in which:

FIG. 1 is a perspective view of a dough base, according to an embodiment of the invention;

FIG. 2 is a cross-sectional view of a pan for accommodating the FIG. 1 dough base, according to an embodiment of the invention;

FIG. 3 is a close-up view of a portion of the FIG. 1 dough base;

FIG. 4 is a perspective view of a tool for creating an impression line, according to an embodiment of the invention;

FIG. 5 is a cross-sectional in-use view taken along line 5-5 of FIG. 4, according to an embodiment of the invention;

FIG. 6 is a close-up view of a portion of the FIG. 5 device;

FIG. 7 is a cross-sectional view taken along line 7-7 of FIG. 1, according to an embodiment of the invention;

FIG. 8 is a perspective view of a dough base being placed in a pan, according to an embodiment of the invention;

FIG. 9 is a perspective view of a pizza in a pan, according to an embodiment of the invention;

FIG. 10 is a perspective view of the FIG. 9 pizza out of the pan, i.e. de-panned, according to an embodiment of the invention;

FIG. 11 is a schematic view of a distribution system, according to an embodiment of the invention; and

FIG. 12 is a perspective view of a stack of dough bases, according to an embodiment of the invention.

### DETAILED DESCRIPTION OF PREFERRED EMBODIMENTS

Certain embodiments of the invention will be described with respect to pizza, pizza dough and other pizza-related products. The invention is not limited to such embodiments, however. On the contrary, embodiments of the invention apply to a wide range of dough products, such as pies and pastries, for example, and to other food products as well. Therefore, although certain embodiments will be described with respect to pizza, the invention is not necessarily limited to pizza.

Aspects of the invention quickly and easily provide a high-walled or “deep dish” style crust using a flat, partially baked (par-baked) crust. An impression line is formed around the rim of an unbaked crust, i.e. layer of raw dough of appropriate shape. After the impression line is formed, the dough is par-baked. The impression line aids in folding the par-baked crust into a pizza pan, such that an outer portion of the crust easily folds or “flips” up, forming a desired, high-walled appearance. A machine, other automated equipment, a hand tool, or other manual technique can be used to create the impression line. Machine-produced impression lines provide impression-line depths and other characteristics that are more consistent from crust to crust and more uniform within a particular crust, and therefore may provide advantages in some situations.

Depending on characteristics of the dough and/or the pan in question, the position, depth and width of the impression line can be optimized. The dough's formulation or flexibility, and the angle of the pan, i.e. the steepness or shallowness of the rim of the pan with respect to the bottom of the pan, are examples of such characteristics. Factors to bear in mind in considering optimization include preventing undesirable tearing, cracking, breaking, or separating of the dough. Such adverse effects can occur when the crust is placed or folded into a pizza pan for baking, at another time in connection with creating a final food product, or in connection with manufacturing the dough. An additional possible adverse effect involves slumping or other deformation in the shape of a high-walled crust created along the impression line. Impression line characteristics can be optimized to help retain the shape of the high-walled crust both during the manufacturing process, e.g. before a dough base is shipped to a restaurant, or afterwards.

In connection with a restaurant or other destination, aspects of the invention provide a par-baked pizza crust that operators can guide or fold easily into a pizza pan or other receptacle to produce a high-walled crust. The crust folds readily and creates a well-defined corner at the fold. The corner and the high-walled crust retain their shape after final baking and de-panning, and/or after a period of refrigeration, and have strength sufficient to survive a cutting operation, e.g. the cutting of a baked pizza into slices for serving to customers, as well as boxing and delivery operations. Whereas previous par-baked doughs suffer considerable cracking and other adverse effects upon attempted folding, embodiments of the invention allow par-baked dough to be folded without operationally significant adverse effect, to create a high-walled crust.

Thus, aspects of the invention provide advantages over many prior crusts having tall sides. Examples of these advantages include: simplified production processes, which increase supplier availability and reduce investment requirements, reduced packaging requirements, which protect crusts from breakage simply and cost-effectively, and reduced cost per crust. Aspects of the invention provide a high-walled crust that is produced and par-baked at a supplier and delivered to pizza restaurants in a ready-to-use form. No special pizza pans or other receptacles are required for receiving and holding a crust during the topping or baking process. Standard, pre-existing pans can be used. Further, crusts according to embodiments of the invention can be stacked for shipment without damaging or otherwise adversely affecting them. Other advantages will be apparent from the remainder of this description.

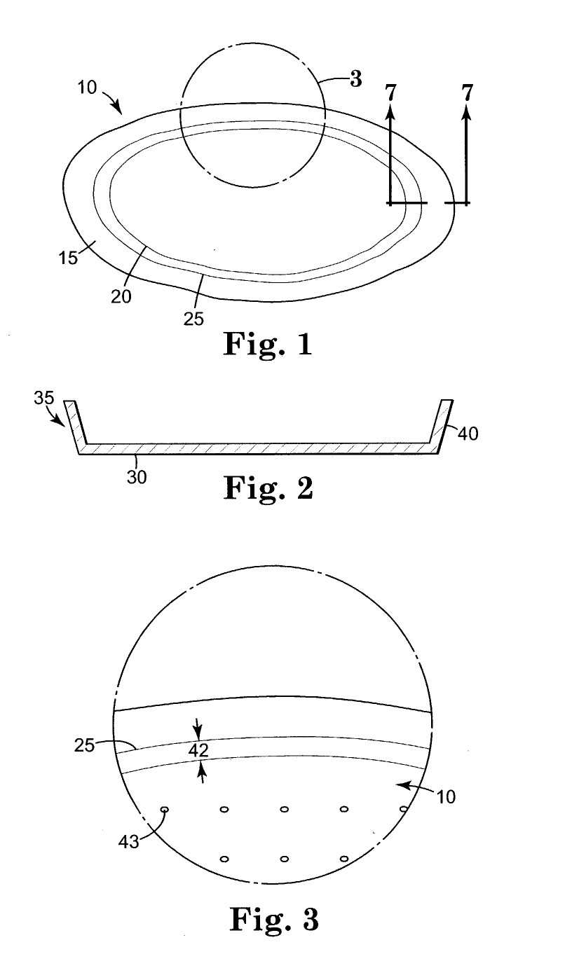

FIG. 1 illustrates dough base 10 having outer portion 15, inner portion 20, and impression line 25 between outer portion 15 and inner portion 20. Dough base 10 is par-baked, according to embodiments of the invention, after impression line 25 is formed. Dough base 10 in that case is a par-baked dough base. Impression line 25 is adapted to aid bending of dough base 10, as will be described. Inner portion 20 of dough base 10 generally corresponds to bottom 30 of receptacle 35 (FIG. 2), for example a pizza pan, into which dough base 10 will be placed. Outer portion 15 of dough base 10 generally corresponds to rim 40 upstanding from bottom 30 of receptacle 35. Dough base 10 is generally flat, according to embodiments of the invention.

FIG. 3 is a close-up view of a portion of the FIG. 1 dough base. Impression line 25 is shown to define a width 42, according to this embodiment. Dough base 10 optionally includes docking holes 43 for aiding a baking process, as will be appreciated by those of ordinary skill.

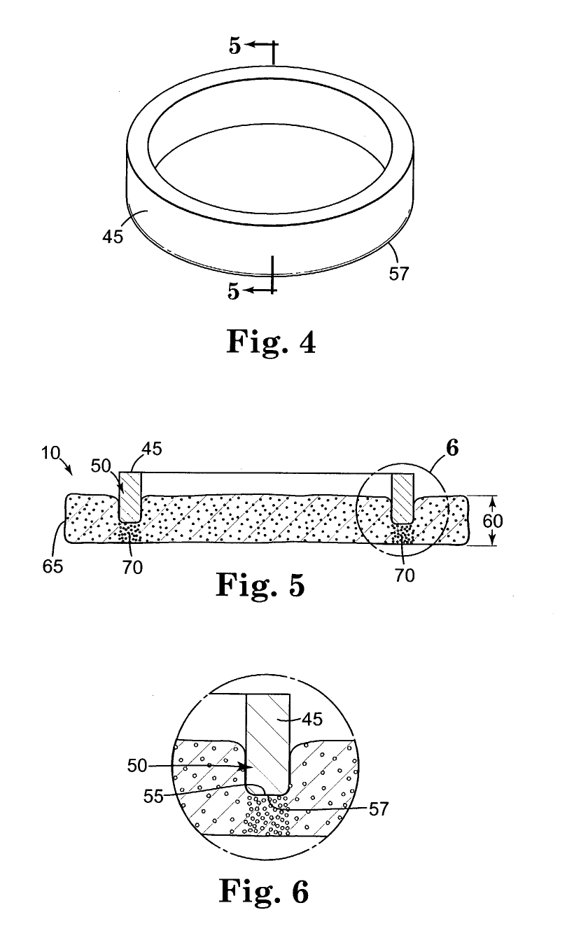

FIGS. 4-6 show ring-shaped pressing device 45 for creating impression line 25 prior to par-baking, according to aspects of the invention. Additional detail regarding device 45 will be described below. Impression line 25 comprises a depression or indentation 50 in dough base 10, at least when pressing device 45 is first pressed into dough base 10 to form impression line 25 and, depending on the particular type of dough, temporarily or permanently after pressing device 45 is removed from dough base 10. A cross-section of depression 50 defines a generally square or generally rectangular shape, as shown, corresponding to the cross-sectional shape of pressing device 45. Bottom 55 of depression 50 defines a generally flat shape, according to embodiments of the invention. Similarly, dough-contacting edge 57 of pressing device 45 is generally flat with generally rounded edges, creating the generally corresponding shape of depression 50. Although other dimensions may be more suitable or less suitable for a particular dough formulation or characteristic, edge 57 is about three-quarters of an inch wide (as viewed in FIGS. 5-6), according to one embodiment.

Dough base 10 defines thickness 60 and outer edge 65. Depression 50 extends about halfway into thickness 60, according to aspects of the invention. With the illustrated embodiment, pressing device 45 is pressed about halfway into thickness 60 to form depression 50. According to other aspects, depression 50 extends no more than about halfway into thickness 60, and/or depression 50 extends between about three-eighths and about halfway into thickness 60. Depression 50 is between about one-half inch and about one inch wide, according to one aspect, more specifically between about five-eighths inch and about seven-eighths inch wide, and more specifically about three-quarters of an inch wide, according to particular embodiments of the invention. Over time, depression 50 becomes narrower and shallower according to particular embodiments, as will be explained.

According to alternative embodiments, the cross-section of depression 50 is of other shapes. For example, bottom 55 defines an angled shape, according to one embodiment, with a depth ranging from one-half the thickness 60 of dough base 10 at an inner edge of depression 50 to zero depth at an outer edge of depression 50, i.e. with no indentation at the outer edge of the tool used to create depression 50 of this shape. Depression 50 has a total width of about 0.75 inches, according to this embodiment. A V-shaped depression 50 is contemplated as well, according to an alternative embodiment. According to an additional alternative embodiment, impression line 25 is a double impression line, such that it defines a double hinge. Each hinge bends about 45 degrees, according to this embodiment, instead of about 90 degrees according to other particular embodiments referenced herein. According to one embodiment, an outer press line of about 0.375-inch groove width runs generally parallel to an inner press line of about 0.375-inch groove width. Other variations in impression line 25 will be apparent to those of ordinary skill upon reading this disclosure.

Ultimately, impression line 25 becomes visually indistinguishable or minimally distinguishable in shape from inner portion 20 of dough base 10 and outer portion 15 of dough base 10, according to certain embodiments. Dough of dough base 10 “puffs up” and/or otherwise partially or completely fills in depression 50 both horizontally and vertically, for example during a proofing process and/or due to the natural leavening action of yeast in the dough, to decrease the depth and width of depression 50 until it is of greatly reduced depth and width, even generally zero depth and width in some cases. Additional features in this regard are described below. According to certain embodiments, impression line 25 becomes a different color than inner portion 20 of dough base 10 and outer portion 15 of dough base 10, so that it can be visualized by color in addition to shape, or by color alone in the case where impression line 25 is visually indistinguishable in shape.

Impression line 25 is a continuous impression line around entire dough base 10, according to the illustrated embodiment, spaced inwardly from outer edge 65. Impression line 25 is between about five-eighths of an inch and about three-fourths of an inch wide, according to certain embodiments, more specifically about three-fourths of an inch wide or slightly less than about three-fourths of an inch wide. According to other interpretations and embodiments, impression line 25 is about one-quarter of an inch wide or less, or more than about three-quarters of an inch wide. Other dimensions are contemplated, as are discontinuous (e.g. “dashed”) impression lines if desired. Optimal dimensions can depend on e.g. characteristics of the particular dough base in question, including the flexibility and thickness thereof, for example.

With reference to e.g. FIGS. 5-7, pressing on dough base 10 to create impression line 25 creates dense area 70 in the dough of dough base 10, i.e. an area of relatively high or increased dough density relative to surrounding dough 75. According to additional aspects of the invention, then, impression line 25 is or includes a line of increased dough density. Area 70 extends entirely or partially to the bottom of dough base 10. Its increased density is caused, at least in part, by pressing device 45, or the tool or other device used to press against dough base 10 to create impression line 25. Pressing device 45 or other device compresses dough from area 80 into area 70, increasing dough density in area 70. Back pressure applied e.g. by the surface on which dough base 10 rests, combined with the pressure exerted by pressing device 45, compresses dough in dough base 10 to form area 70, according to aspects of the invention.

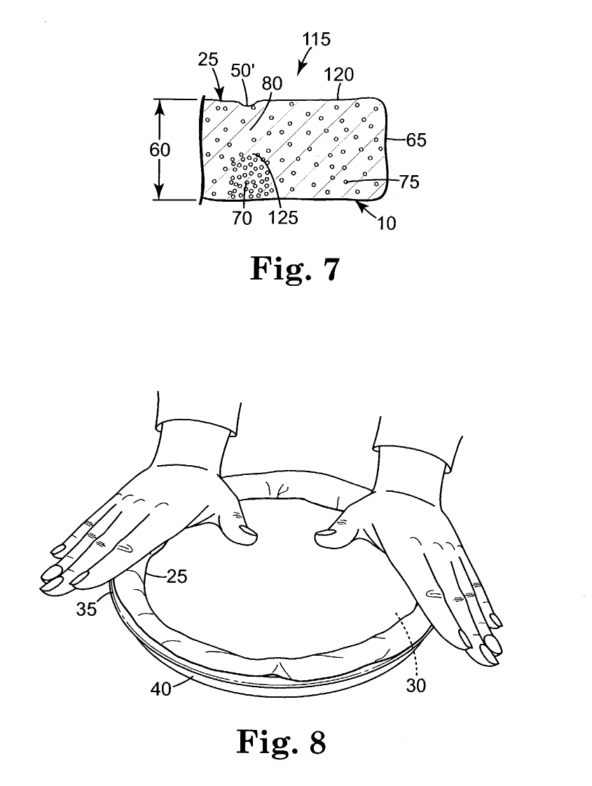

Over time, once pressing device 45 is removed, dough expands from unaffected area 75 and/or dense area 70 into depression 50, as referenced earlier. This expansion creates area 80, which is of lesser density than area 70 and area 75, according to certain embodiments. According to other embodiments, dough density in area 80 is generally the same as that in area 75. Thus, a par-baked dough base 10 includes area 70 of increased dough density, area 75 of normal or unaffected dough density, and area 80 of normal/unaffected dough density or reduced dough density. Impression line 25 is considered to be one or both of areas 70, 80, according to various embodiments of the invention, and thus is defined by or includes a dough density differential. Depression 50 becomes completely filled in or partially filled in, according to embodiments of the invention. For example, as shown in FIG. 7, depression 50 has become depression 50′, which is of reduced width and depth compared to depression 50 in FIGS. 5-6. According to particular embodiments, depression 50′ is of about one-quarter inch in width.

According to additional aspects of the invention, dough base 10 defines outer edge 65 and has a first dough density e.g. in area 75. Dough base 10 includes line 25 of second dough density spaced inwardly from outer edge 65, line 25 of second dough density being adapted to promote folding of dough base 10, the first dough density being different than the second dough density. In the case where the second dough density is that of area 80, the second dough density is less than the first dough density. In the case where the second dough density is that of area 70, the second dough density is greater than the first dough density. Dough base 10 also has a third dough density adjacent the second dough density. In the case where the third dough density is that of area 80, the third dough density is less than the first dough density and the second dough density. Dough base 10 is a par-baked dough base, according to aspects of the invention.

Line 25 of increased and/or decreased dough density is adapted to promote folding of dough base 10, as will be described. Line 25 is generally circular, according to the illustrated embodiment, and generally parallel to outer edge 65 of dough base 10, e.g. the entire outer edge 65 of dough base 10. As will be appreciated, line 25 generally corresponds to an area of intersection between bottom 30 of pizza pan 35 and rim 40 of pizza pan 35 (FIG. 2). Dough base 10 thus includes means 25 for encouraging a bend in dough base 10 at a junction or intersection between inner portion 20 of dough base 10 and outer portion 15 of dough base 10, without cutting or tearing of dough base 10. The means 25 for encouraging comprises impression area 70 and/or 80, which are internal to dough base 10. This impression area is visually indistinguishable or minimally distinguishable in shape from inner portion 20 and outer portion 15 of dough base 10, according to embodiments of the invention, as referenced above. Dough base 10 is a par-baked dough base, according to aspects of the invention.

Area 70 of increased dough density generally is more resistant to proofing and cooking than surrounding areas. Additionally, moisture can tend to collect in the depression or indentation 50. Dough separation can occur if indentation 50 is too deep, resulting in easily detachable crust edges. Minimizing or eliminating these issues, e.g. by minimizing or otherwise optimizing the width, depth, and/or extent of depression or indentation 50, may provide advantages in certain situations.

A method of preparing dough base 10 includes creating impression line 25 in dough base 10 between outer portion 15 of dough base 10 and inner portion 20 of dough base 10. Inner portion 20 of dough base 10 generally corresponds to bottom 30 of receptacle 35 into which dough base 10 will be placed. Outer portion 15 of dough base 10 generally corresponds to rim 40 upstanding from bottom 30 of receptacle 35 into which dough base 10 will be placed. Par-baking of dough base 10 occurs after creating impression line 25, for example. Impression line 25 is adapted to aid bending of dough base 10 along impression line 25, and comprises depression 50 in dough base 10. The method further includes decreasing the depth of depression 50 in dough base 10, for example, until impression line 25 is of minimal depth and width and/or is visually indistinguishable in shape from inner portion 20 of dough base 10 and outer portion 15 of dough base 10. The decreasing step occurs without physically contacting impression line 25, for example as dough naturally fills in depression 50. According to embodiments of the invention, depression 50 decreases in depth due to or in connection with proofing or par-baking of dough base 10, other rising of the dough in dough base 10, and/or spring-back or other shape-retention features of the dough. Although depression 50 thereby practically or entirely “disappears,” the dough of dough base 10 retains a memory of where depression 50 was, thereby maintaining a fully functional, though not necessarily visible, impression line 25 with little or no visible width or depth. Impression line 25 may retain a color difference or a shallow depth, according to embodiments of the invention. The color difference occurs as a natural result of the impression and fill-in process and not with the aid of food coloring or other external coloring, according to specific embodiments.

Methods according to embodiments of the invention also include placing par-baked dough base 10 into receptacle 35 and bending dough base 10 along impression line 25 such that outer portion 15 of dough base 10 is generally adjacent rim 40 of receptacle 35, and inner portion 20 of dough base 10 is generally adjacent bottom 30 of receptacle 35. Note FIG. 8, for example. During a proofing step, according to certain aspects of the invention, impression line 25 becomes visually indistinguishable or minimally distinguishable in shape from the remainder of dough base 10. According to additional aspects of the invention, the method includes pressing generally ring-shaped pressing device 45 (FIGS. 4-6) into dough base 10 to form impression line 25. Dough contacting edge 57 of pressing device 45 is generally flat with generally rounded edges, as shown in e.g. FIG. 6, creating a generally corresponding shape of depression 50. Although other dimensions may be more suitable or less suitable for a particular dough formulation or characteristic, edge 57 is about three-quarters of an inch wide, according to one embodiment.

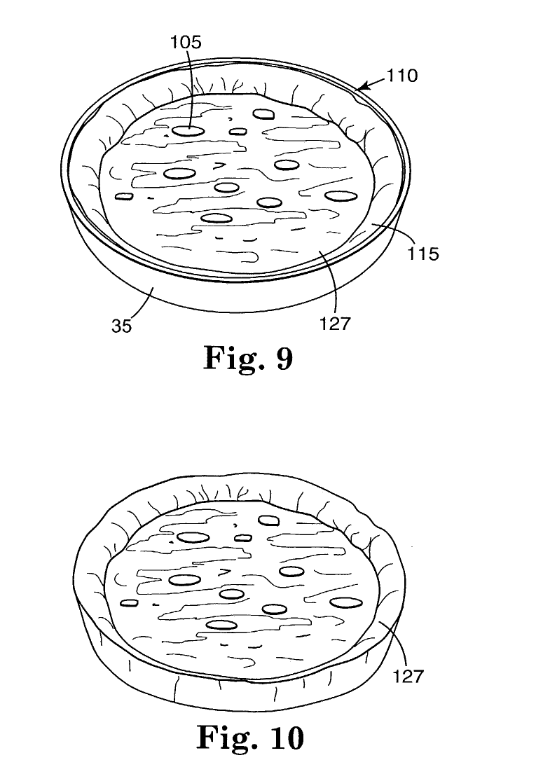

As represented in e.g. FIG. 8, a method according to an embodiment of the invention includes manually placing dough base 10 into pizza pan or other receptacle 35 and folding dough base 10 at or near impression line or line of increased dough density 25, to place line 25 at the area of intersection between bottom 30 of pizza pan or other receptacle 35 and rim 40 thereof to form a high-walled pizza crust. Dough base 10 is pressed and folded into the pan using just the palms, for example. Of course, fingers, knuckles, other parts of the hands, spoons or other tools, or other devices, also can be used. Pan 35 is turned as needed during the pressing operation. Once dough base 10 is placed and folded as desired, certain cheese and pizza toppings 105 are added to dough base 10 to form pizza 110, shown in FIG. 9, which then can be baked and served, or partially baked, and/or frozen, refrigerated or otherwise preserved.

According to additional features of the invention, with reference to e.g. FIG. 7, par-baked dough 115, for example pizza dough, includes generally flat surface 120 and fold line 125 beneath generally flat surface 120, the par-baked dough 115 being adapted to fold along fold line 125. Fold line 125 is defined by or includes a dough density differential, and is formed by applying pressing device 45 to dough 115 before dough 115 is par-baked, according to one embodiment. Fold line 125 includes or is defined by area 70 of increased dough density and/or area 80 of decreased dough density, relative to remainder 75 of the dough. Dough 115 defines generally constant thickness 60, and fold line 125 is formed by indenting an area of dough 115 to a depth of about one-half of thickness 60. According to additional embodiments, fold line 125 is formed by indenting an area of par-baked dough 115 to a fraction of thickness 60 of dough 115 without cutting dough 115, pizza dough 115 being adapted to fold along fold line 125. Pizza 110 is formed of pizza dough 115 according to one embodiment.

According to an additional aspect, pizza dough base 10 is par-baked and is or includes a generally flat, generally circular slab of pizza dough. The slab has an external circumference and a thickness, and a generally circular impression area 25 extending around the slab. Impression area 25 is spaced inwardly from the external circumference of the slab by a generally constant distance that is generally equal to the length of rim 40 of pizza pan 35 into which dough base 10 is to be placed. That distance is anywhere between 1.0 and about 1.5 inches, according to particular examples. Impression area 25 has a dough density that differs from dough density in the remainder of dough base 10. According to one embodiment, impression area 25 extends only about halfway into thickness 60 of pizza dough base 10. Impression area 25 is less than about one inch wide and defines a generally square or generally rectangular cross section, according to embodiments of the invention. Further, pizza dough base 10 is adapted to fold along impression area 25 such that impression area 25 is adapted for placement immediately adjacent the intersection between rim 40 of pizza pan 35 and bottom 30 of pizza pan 35. Impression area 25 is adapted to promote folding of pizza dough base 10 to create a high-walled pizza crust, for example high-walled pizza crust 127.

High-walled pizza crust 127 according to embodiments of the invention retains its shape after de-panning, as represented in e.g. FIG. 10. Crust 127 also has the strength to survive a cutting operation, e.g. cutting of a pizza into slices for serving to customers. The high-walled portion of crust 127 remains upright and straight, according to embodiments of the invention, to retain favorable appearance, handling characteristics and other characteristics even when de-panned. Thus, method embodiments according to the invention provide baking pizza 110 and removing pizza 110 from pizza pan 35, wherein high-walled pizza crust 127 retains its shape after pizza 110 is removed from pizza pan 35.

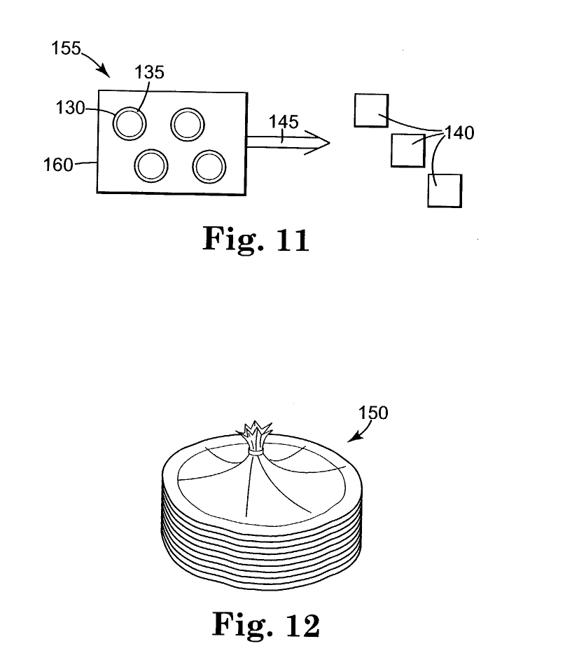

According to additional aspects of the invention, a pizza dough distribution method includes forming a plurality of generally flat pizza dough bases 130, illustrated in e.g. FIG. 11 and corresponding to those previously described. The method further includes indenting each generally flat pizza dough base 130 around inner periphery 135 thereof, and shipping generally flat pizza dough bases 130 to at least one restaurant 140 or other establishment. The shipping can be by truck, using a private or public courier or transportation service, for example. The shipping step is represented generally by arrow 145. Because folding occurs at restaurants 140, dough bases 130 can be shipped flat and stacked, as indicated at 150 in FIG. 12, thereby reducing packaging volume. Stack 150 is composed of multiple, generally identical dough bases 130, as will be appreciated, and can be placed in a bag or other packaging. The method further includes folding each generally flat pizza dough base 130 along inner periphery 135 at the at least one restaurant 140 to form a high-walled pizza crust. Par-baking of the generally flat pizza dough bases 130 occurs before shipping step 145 and after the indenting step. The indenting step includes producing indentation 50 in generally flat pizza dough base 130, indention 50 having a depth, the method further comprising reducing the depth of indentation 50, for example as previously described. Distribution methods according to embodiments of the invention simplify the operational procedures needed at restaurants 140 to create high-walled crust pizzas and provide other advantages.

Pizza dough distribution system 155 according to an aspect of the invention includes pizza dough processing facility or other supplier 160 having at least one pizza dough pressing device 45. A plurality of pizza dough bases 130 are produced by pizza dough processing facility 160. Pizza dough bases 130 each have fold line 25 created by pizza dough pressing device 45 to promote folding of pizza dough bases 130 along fold line 125. System 155 also includes a plurality of restaurants 140 that serve pizza remote from supplier 160, and shipping arrangement 145 for shipping pizza dough bases 130 from supplier 160 to the plurality of restaurants 140. Fold line 125 of each pizza dough base 130 is visually indistinguishable or minimally distinguishable in shape from the remainder of each pizza dough base 130, e.g. in the manner previously described herein. Fold line 125 of each dough base 130 is disposed beneath generally flat, generally continuous surface 120 of each dough base 130. Dough-base 130 is par-baked at pizza dough processing facility 160 before shipping. Further, each dough base 130 is generally flat and is shipped generally flat to restaurant 140 that serves pizza, for example in stack 150. Each dough base 130 is manually folded at restaurant 140 along impression line 25 or fold line 125.

According to specific aspects, one type of supplier process according to an embodiment of the invention includes mixing ingredients to form dough and then sheeting the dough. A die-cut process cuts the sheet into multiple desired shapes, e.g. circular shapes, to form dough bases 130. Proofing and par baking occur. Dough bases 130 are par-baked at between about 200 degrees and about 500 degrees Fahrenheit in a multi-zoned oven for between about one minute and about three minutes, according to specific examples, although other temperatures and times are contemplated if desired. Each dough base 130 is indented to form impression line or area 25. The indenting step can occur before or after proofing. Primary embodiments of the invention provide the indenting step before a par-baking step. Dough bases 130 are ultimately shipped in a par-baked, frozen and packed state. Restaurants 140 then receive stacks of frozen dough bases 130 in bags and/or boxes. The dough is thawed at room temperature, for example. Prior to topping and baking, each base 130 is pressed into pan 35 or other receptacle to form a high-walled pizza crust. Variations in the order and nature of the various recited steps are contemplated according to the invention.

According to a particular embodiment of dough base construction, a high-walled pizza crust formed from dough base 10 or 130 has a top outer diameter of about 11.5 to about 11.75 inches and a bottom outer diameter of about 11.25 inches. Crust height is about 1.2 to about 1.4 inches, with a bottom thickness and edge thickness of about 0.55 to about 0.75 inches. Edge appearance presents a generally straight wall, angled to fit the pan or other receptacle, and a rounded top. The dough base originates from a dough ball of about 21 ounces, or about 18.5 ounces par-baked.

According to a particular embodiment of dough preparation e.g. at pizza restaurant or other establishment 140, bagged stacks 150 are received are thawed and placed in a proofer in single stacks. Stacks 150 are proofed for between about 2.0 hours and about 4 hours, as needed, and/or until the crusts in each stack 150 feel soft. Stacks 150 are removed from the proofer, and each dough base or crust 10 is centered over a respective clean, dry pizza pan 35.

Starting with outside edge 65 of crust 10, a restaurant employee or other person pushes the sides of crust 10 down and into pan 35, using only the palms and with the thumbs up and out of the way, according to one embodiment. The employee rotates the pan while pushing, gradually working from outside edge 65 of crust 10 to a slightly inward of crust 10. Pushing on the bottom of crust 10, for example the portion of crust 10 immediately adjacent bottom 30 of pan 35, is not necessary or recommended, according to one embodiment. The employee need not see impression line 25 or know where it is; crust 10 retains memory of impression line 25 and folds there automatically upon palming and turning as described. Crust 10 then optionally is refrigerated and stored for later use.

According to a particular embodiment of pizza construction, a par-baked crust as described herein is folded into a medium-sized pizza pan, e.g. having a top (rim) diameter of about 12 inches and a bottom diameter of about 11.5 inches. The par-baked crust is topped with e.g. a layer of cheese. Selected quantities of toppings, e.g. sausage, mushrooms, green peppers, and red onions, totaling 12 ounces or another desired amount, are placed on top of the cheese layer. A second cheese layer is placed over the toppings. The product then is baked at a desired temperature for a desired, e.g. relatively short, period of time. According to one example, the product is baked at about 440 degrees Fahrenheit for about 8 minutes. An additional ingredient then is applied, if desired, e.g. a selected quantity of hot marinara sauce. The pizza product then is cut and either boxed or served.

Those of ordinary skill in the art upon reading this disclosure will appreciate the wide variety of dimensions, temperatures, times and other parameters that are contemplated according to the invention, as may be desired for particular types of dough, types of food product, serving or manufacturing environment, etc. Additionally, the term “fold” should not necessarily be interpreted to require partial or complete doubling over, for example such that one side of a folded structure is approaching or is in physical contact with another side of the folded structure. The term “line” is not limited to a strict definition based on mathematics or geometry, but for example can be an area having width and depth according to certain interpretations herein. The illustrations of dough density in e.g. FIGS. 5-7 are to schematically emphasize differences in dough density and not necessarily to indicate physically open areas in the dough. Features and advantages described with respect to any one figure or embodiment should be considered to apply equally to any other figure or embodiment herein. Other features and advantages according to the invention will be apparent from the disclosure to those of ordinary skill.

What is claimed is:

1. A dough base, comprising:
an outer portion;
an inner portion; and
an impression line between the outer portion of the dough base and the inner portion of the dough base, the impression line being adapted to aid bending of the dough base along the impression line;
wherein the inner portion of the dough base generally corresponds to the bottom of a receptacle into which the dough base will be placed;
further wherein the outer portion of the dough base generally corresponds to a rim upstanding from the bottom of the receptacle into which the dough base will be placed.

2. The dough base of claim 1, wherein the impression line comprises a depression in the dough base.

3. The dough base of claim 2, wherein the dough base defines a thickness; further wherein the depression extends about halfway into the thickness.

4. The dough base of claim 2, wherein a cross-section of the depression defines a generally square shape or generally rectangular shape.

5. The dough base of claim 2, wherein a bottom of the depression defines a generally flat shape.

6. The dough base of claim 1, wherein the dough base is a par-baked dough base.

7. The dough base of claim 1, wherein the impression line is a different color than the inner portion of the dough base and the outer portion of the dough base.

8. The dough base of claim 1, wherein the impression line is a continuous impression line around the entire dough base.

9. The dough base of claim 1, wherein the impression line is between about five-eighths of an inch and about three-fourths of an inch wide.

10. The dough base of claim 9, wherein the impression line is less than about three-fourths of an inch wide.

11. The dough base of claim 1, wherein the dough base is generally flat.

12. The dough base of claim 11, in combination with multiple identical dough bases to form a stack of dough bases.

13. A par-baked dough base defining an outer edge and a line of increased dough density spaced inwardly from the outer edge, the line of increased dough density being adapted to promote folding of the dough base.

14. The dough base of claim 13, wherein the line of increased dough density is generally circular.

15. The dough base of claim 13, wherein the line of increased dough density is generally parallel to the outer edge of the dough base.

16. The dough base of claim 15, wherein the line of increased dough density is generally parallel to the entire outer edge of the dough base.

17. The dough base of claim 13, wherein the line of increased dough density generally corresponds to an area of intersection between a bottom of a pizza pan and a rim of the pizza pan.

18. A dough base defining an outer edge and having a first dough density, the dough base including a line of second dough density spaced inwardly from the outer edge, the line of second dough density being adapted to promote folding of the dough base, the first dough density being different than the second dough density.

19. The dough base of claim 18, wherein the second dough density is less than the first dough density.

20. The dough base of claim 18, wherein the second dough density is greater than the first dough density.

21. The dough base of claim 20, wherein the dough base has a third dough density adjacent the second dough density, wherein the third dough density is less than the first dough density and the second dough density.

22. The dough base of claim 18, wherein the dough base is a par-baked dough base.

23. A method of preparing a dough base, the method comprising creating an impression line in the dough base between an outer portion of the dough base and an inner portion of the dough base, the inner portion of the dough base generally corresponding to the bottom of a receptacle into which the dough base will be placed, the outer portion of the dough base generally corresponding to a rim upstanding from the bottom of the receptacle into which the dough base will be placed, the impression line being adapted to aid bending of the dough base along the impression line.

24. The method of claim 23, wherein the impression line comprises a depression in the dough base, the method further comprising decreasing the depth of the depression in the dough base.

25. The method of claim 23, further comprising par-baking the dough base after creating the impression line.

26. The method of claim 25, further comprising bending the dough base along the impression line.

27. The method of claim 25, further comprising placing the par-baked dough base into the receptacle and bending the dough base along the impression line such that the outer portion of the dough base is generally adjacent the rim of the receptacle and the inner portion of the dough base is generally adjacent the bottom of the receptacle.

28. The method of claim 23, further comprising proofing the dough base.

29. The method of claim 28, wherein during the proofing step the impression line becomes visually indistinguishable in shape from the remainder of the dough base.

30. The method of claim 23, wherein the dough base is generally flat, the method further comprising shipping the generally flat dough base to a restaurant that serves pizza.

31. The method of claim 30, further comprising manually folding the dough base along the impression line at the restaurant.

32. The method of claim 23, further comprising pressing a generally ring-shaped pressing device into the dough base to form the impression line.

33. A method of preparing a par-baked dough base, the method comprising:
creating a line of increased dough density in the dough base, the line being spaced inwardly from an outer edge of the dough base, the line of increased dough density being adapted to promote folding of the dough base; and
par-baking the dough base.

34. The method of claim 33, wherein the line of increased dough density corresponds to an area of intersection between a bottom of a pizza pan and a rim of the pizza pan.

35. The method of claim 34, further comprising manually placing the dough base into the pizza pan and folding the dough base at or near the line of increased dough density to place the line of increased dough density at the area of intersection between the bottom of the pizza pan and the rim of the pizza pan and to form a high-walled pizza crust.

36. The method of claim 35, further comprising adding cheese and pizza toppings to the dough base to form a pizza.

37. The method of claim 36, further comprising baking the pizza and removing the pizza from the pizza pan, wherein the high-walled pizza crust retains its shape after the pizza is removed from the pizza pan.

38. A pizza produced by a method comprising:
creating a line of increased dough density in a dough base, the line being spaced inwardly from an outer edge of the dough base, the line of increased dough density being adapted to promote folding of the dough base, wherein the line of increased dough density corresponds to the area of intersection between the bottom of a pizza pan and the rim of the pizza pan;
par-baking the dough base;
manually placing the dough base into the pizza pan and folding the dough base at or near the line of increased dough density to place the line of increased dough density at the area of intersection between the bottom of the pizza pan and the rim of the pizza pan and to form a high-walled pizza crust; and
adding cheese and at least one pizza topping to the dough base to form a pizza.

39. Par-baked dough, comprising:
a generally flat surface; and
a fold line beneath the generally flat surface, the par-baked dough being adapted to fold along the fold line.

40. The par-baked dough of claim 39, wherein the fold line is defined by a dough density differential.

41. The par-baked dough of claim 39, wherein the fold line is formed by applying a pressing device to the dough before the dough is par-baked.

42. The par-baked dough of claim 39, wherein the par-baked dough defines a generally constant thickness, further wherein the fold line is formed by indenting an area of the dough to a depth of about one-half the thickness.

43. Par-baked pizza dough having a fold line formed by indenting an area of the pizza dough to a fraction of the thickness of the pizza dough without cutting the pizza dough, the par-baked pizza dough being adapted to fold along the fold line.

44. A pizza formed of the par-baked pizza dough of claim 43.

45. A pizza dough distribution method, comprising:
forming a plurality of generally flat pizza dough bases;
indenting each generally flat pizza dough base around an inner periphery thereof; and
shipping the generally flat pizza dough bases to at least one restaurant.

46. The method of claim 45, further comprising folding each generally flat pizza dough base along the inner periphery at the at least one restaurant to form a high-walled pizza crust.

47. The method of claim 46, wherein the folding occurs using only the palms of a human operator.

48. The method of claim 45, further comprising par-baking the generally flat pizza dough bases before the shipping step and after the indenting step.

49. The method of claim 45, wherein the indenting step includes producing an indentation in the generally flat pizza dough base, the indention having a depth, the method further comprising reducing the depth of the indentation.

50. A pizza dough distribution system, comprising:
a pizza dough processing facility having at least one pizza dough pressing device;
a plurality of pizza dough bases produced by the pizza dough processing facility, the pizza dough bases each having a fold line created by the at least one pizza dough pressing device to promote folding of the pizza dough bases along the fold line;
a plurality of restaurants that serve pizza, remote from the pizza dough processing facility; and
a shipping arrangement for shipping the pizza dough bases from the pizza dough processing facility to the plurality of restaurants.

51. The system of claim 50, wherein the dough base is par-baked at the pizza dough processing facility before shipping.

52. The system of claim 51, wherein the fold line of each dough base is disposed beneath a generally flat, generally continuous surface of each dough base.

53. A dough base, comprising:
an inner portion;
an outer portion; and
means within the dough base for encouraging a bend in the dough base at a junction between the inner portion of the dough base and the outer portion of the dough base without cutting or tearing of the dough base, the means for encouraging comprising an impression area internal to the dough base.

54. The dough base of claim 53, wherein the dough base is a par-baked dough base.

55. A par-baked pizza dough base, comprising:
a generally flat, generally circular slab of par-baked pizza dough, the slab having an external circumference and a thickness; and
a generally circular impression area extending around the slab, the impression area being spaced inwardly from the external circumference of the slab by a generally constant distance, the generally constant distance being generally equal to the length of a rim of a pizza pan into which the dough base is to be placed, the impression area having a dough density that differs from dough density in the remainder of the dough base;
wherein the impression area is less than about one inch wide; further wherein the pizza dough base is adapted to fold along the impression area such that the impression area is adapted for placement adjacent an intersection between the rim of the pizza pan and a bottom of the pizza pan, the impression area being adapted to promote folding of the pizza dough base to create a high-walled pizza crust.
